(19) United States
(12) Patent Application Publication
(10) Pub. No.: US 2015/0222920 A1
(43) Pub. Date: Aug. 6, 2015

(54) IMAGE PROCESSING DEVICE, IMAGING DEVICE, AND IMAGE PROCESSING METHOD

(71) Applicant: KABUSHIKI KAISHA TOSHIBA, Tokyo (JP)

(72) Inventors: Nao MISHIMA, Tokyo (JP); Takeshi MITA, Yokohama (JP)

(21) Appl. No.: 14/612,584

(22) Filed: Feb. 3, 2015

(30) Foreign Application Priority Data
Feb. 6, 2014 (JP) 2014-021744

(51) Int. Cl. H04N 19/513; H04N 19/527

(52) U.S. Cl. CPC H04N 19/521; H04N 19/527

(57) ABSTRACT

According to one embodiment, an image processing device includes a calculator. The calculator acquires image information including a reference frame and a plurality of target frames. The calculator estimates a first motion of the target frames with respect to the reference frame and derives a first stored frame by adding the target frames each of which positions was adjusted based on the first motion. The calculator estimates a second motion of the target frames with respect to the reference frame and derives a second stored frame by adding the plurality of the target frames each of which position was adjusted based on the second motion. The estimation of the second motion is different from the estimation of the first motion. The calculator generates an output frame using the first stored frame and the second stored frame.

### CROSS-REFERENCE TO RELATED APPLICATIONS

This application is based upon and claims the benefit of priority from Japanese Patent Application No. 2014-021744, filed on Feb. 6, 2014; the entire contents of which are incorporated herein by reference.

### FIELD

Embodiments described herein relate generally to an image processing device, an imaging device, and an image processing method.

### BACKGROUND

For example, there is an image processing device that generates an output frame by adding multiple input frames. It is desirable to increase the image quality of the image in such an image processing device.

### BRIEF DESCRIPTION OF THE DRAWINGS

FIG. 1 is a schematic view illustrating the image processing device according to the first embodiment;

FIG. 2 is a schematic view illustrating the image processing method according to the first embodiment;

FIG. 3 is a schematic view illustrating the image processing method according to the first embodiment;

FIG. 4 is a schematic view illustrating the image processing method according to the embodiment;

FIG. 5 is a schematic view illustrating an image processing device according to a second embodiment;

FIG. 6 is a schematic view illustrating the image processing method according to the second embodiment;

FIG. 7 is a schematic view illustrating an image processing device according to a third embodiment;

FIG. 8 is a schematic view illustrating the image processing method according to the third embodiment;

FIG. 9 is a schematic view illustrating an image processing device according to a fourth embodiment; and

FIG. 10 is a schematic view illustrating an imaging device according to a fifth embodiment.

### DETAILED DESCRIPTION

According to one embodiment, an image processing device includes a calculator. The calculator acquires image information including a reference frame and a plurality of target frames. The calculator estimates a first motion of each of the plurality of the target frames with respect to the reference frame and derives a first stored frame by adding the plurality of the target frames each of which positions was adjusted based on the first motion. The calculator estimates a second motion of each of the plurality of the target frames with respect to the reference frame and derives a second stored frame by adding the plurality of the target frames each of which positions was adjusted based on the second motion. The estimation of the second motion is different from the estimation of the first motion. The calculator generates an output frame using the first stored frame and the second stored frame.

According to one embodiment, an image processing device includes a calculator that acquires a first image and a second image. The calculator derives a first processed image by moving, based on a first vector, at least a portion of second image information inside the second image and adding the portion of the second image information to the first image after the movement. A first region of the first image includes first image information. A second region of the second image includes the second image information corresponding to the first image information. The first vector corresponds to the difference between a position of the first region and a position of the second region. The calculator derives a second processed image by moving, based on a second vector, at least a portion of fourth image information inside the second image and adding the portion of the fourth image information to the first image after the movement. A third region of the first image includes third image information. A fourth region of the second image includes the fourth image information corresponding to the third image information. The second vector corresponds to the difference between a position of the third region and a position of the fourth region. The calculator generates an output image using the first processed image and the second processed image.

According to one embodiment, an image processing method is disclosed. The method includes acquiring image information including a reference frame and a plurality of target frames. The method includes estimating a first motion of each of the plurality of the target frames with respect to the reference frame and deriving a first stored frame by adding the plurality of target frames each of which positions was adjusted based on the first motion. The method includes estimating a second motion of each of the plurality of the target frames with respect to the reference frame and deriving a second stored frame by adding the plurality of the target frames each of which positions was adjusted based on the second motion. The estimation of the second motion is different from the estimation of the first motion. The method includes generating an output frame using the first stored frame and the second stored frame.

According to one embodiment, an image processing device includes one or more processing circuits. The one or more processing circuits acquire image information including a reference frame, a first target frame and a second target frame. The one or more processing circuits estimate a first motion of the first target frame with respect to the reference frame by a first motion estimation processing. The one or more processing circuits estimate a second motion of the second target frame with respect to the reference frame by the first motion estimation processing. The one or more processing circuits derive a first stored frame by adding a third target frame and a fourth target frame. The third target frame is obtained by adjusting a position of the first target frame based on the first motion. The fourth target frame is obtained by adjusting a position of the second target frame based on the second motion. The one or more processing circuits estimate a third motion of the first target frame with respect to the reference frame by a second motion estimation processing. The one or more processing circuits estimate a fourth motion of the second target frame with respect to the reference frame by the second motion estimation processing. The second motion estimation processing is different from the first motion estimation processing. The one or more processing circuits derive a second stored frame by adding a fifth target frame and a sixth target frame. The fifth target frame is obtained by adjusting the position of the first target frame based on the third motion. The sixth target frame is obtained by adjusting position of the second target frame based on the fourth motion. The one or more processing circuits generate an output frame using the first stored frame and the second stored frame.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

The embodiment relates to an image processing device, an imaging device, and an image processing method.

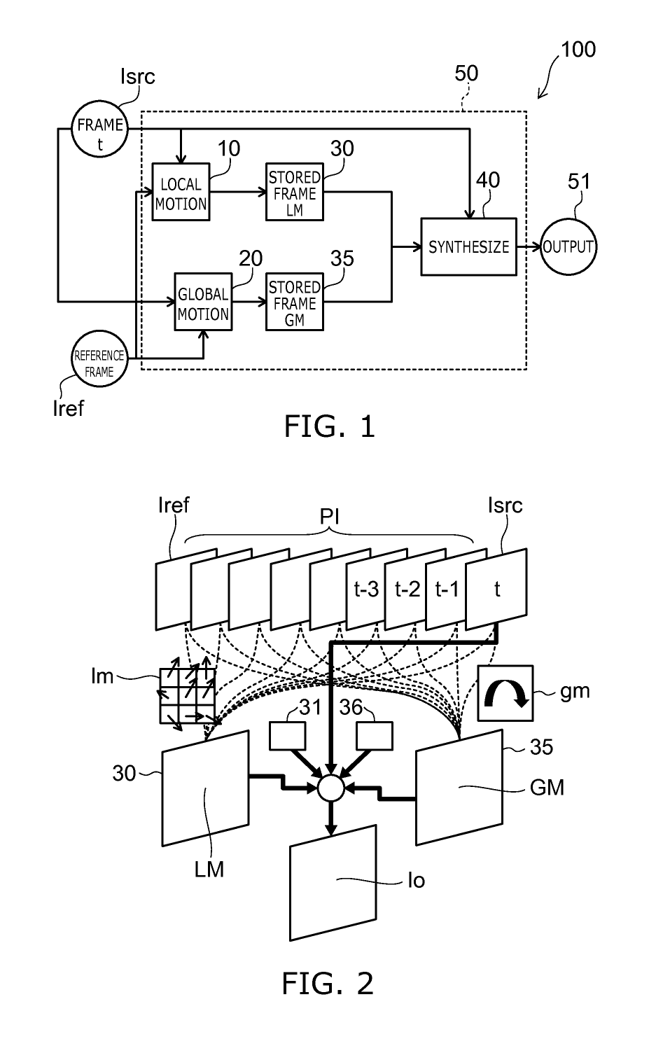

FIG. 1 is a schematic view showing the image processing device according to the first embodiment.

As shown in FIG. 1, the image processing device 100 includes a calculator 50 and an output unit 51. The calculator 50 includes a local motion estimator 10, a global motion estimator 20, a first storage buffer 30, a second storage buffer 35, and a synthesizer 40.

The calculator 50 acquires image information including an input frame I_{src} (target frame) and a reference frame I_{ref}. The local motion estimator 10 and the global motion estimator 20 estimate, based on the input frame I_{src} and the reference frame I_{ref}, the motion of an image (e.g., the difference between the position of a subject in the image of the input frame I_{src} and the position of the subject in the image of the reference frame I_{ref}).

The local motion estimator 10 (a first motion estimation unit) subdivides the entire image into multiple regions and estimates a first motion (the local motion) of the input frame I_{src} with respect to the reference frame I_{ref} for each of the regions (first motion estimation processing). The local motion is expressed by a vector (a motion vector). The local motion uses at least two motion parameters (parameters expressing the motion) for the entire screen.

The global motion estimator 20 (a second motion estimation unit) estimates a second motion (the global motion) of the entire input frame I_{src} with respect to the entire reference frame I_{ref} (second motion estimation processing). The global motion (the second motion) is expressed by, for example, a motion vector. The global motion may be expressed by a parameter of rotation, a parameter of translation, etc. The global motion uses one motion parameter for the entire screen.

The first storage buffer 30 and the second storage buffer 35 are buffers that store the input frame I_{src}.

Based on the motion vector estimated by the local motion estimator 10, the position of the image of the input frame I_{src} is caused to match the position of the image of the reference frame I_{ref} (warping is performed). Based on the motion vector of the local motion, the image of the input frame I_{src} for which the warping is performed is stored in the first storage buffer 30.

Based on the motion vector estimated by the global motion estimator 20, the position of the image of the input frame I_{src} is caused to match the position of the image of the reference frame I_{ref}. Based on the motion vector of the global motion, the input frame I_{src} for which the warping is performed is stored in the second storage buffer 35.

The synthesizer 40 generates an output frame (an output image) by synthesizing the input frame I_{src}, the frame (the first processed image) that is stored in the first storage buffer 30, and the frame (the second processed image) that is stored in the second storage buffer 35. In the synthesis, for example, the weight of each pixel described below is considered. Thereby, a high quality image in which the noise is suppressed is generated. The image that is generated is output by the output unit 51.

The first image (the image of the reference frame I_{ref}) includes a first region including first image information. The local motion estimator 10 subdivides the second image (the image of the input frame I_{src}) into multiple regions including a second region. For example, each of the multiple regions has a first surface area. The second region includes second image information that corresponds to the first image information. The first image information and the second image information are, for example, information of a subject inside the image. The local motion estimator 10 estimates the difference (the local motion) between the position of the first region in the first image and the position of the second region in the second image. A first vector that corresponds to the difference (the local motion) is calculated.

The first image includes a third region including third image information. The second image includes a fourth region including fourth image information. The third image information and the fourth image information are, for example, information of the subject inside the image. For example, the surface area of the fourth region is different from the surface area (the first surface area) of the second region. The third image information corresponds to the fourth image information. For example, in the global motion estimator 20, the entire second image is used as the fourth region. The global motion estimator 20 estimates the difference (the global motion) between the position of the third region in the first image and the position of the fourth region in the second image. A second vector that corresponds to the difference (the global motion) is calculated.

Based on the first vector, at least a portion of the second image information is moved inside the second image; and the at least a portion of the second image information after being moved is added to the first image. Thereby, the first processed image is derived. The first processed image is stored in the first storage buffer 30.

Based on the second vector, at least a portion of the fourth image information is moved inside the second image; and the at least a portion of the fourth image information after being moved is added to the first image. Thereby, the second processed image is derived. The second processed image is stored in the second storage buffer 35.

The synthesizer 40 calculates (generates) the output image using the first processed image and the second processed image. The output unit 51 outputs the output image that is calculated.

FIG. 2 is a schematic view showing the image processing method according to the first embodiment.

As shown in FIG. 2, an input image PI includes multiple frames. One frame of the multiple frames is acquired as the input frame I_{src}. In the example, the input image PI is a video image. The input image PI may be multiple static images. For example, the frames that are used as the input image PI are acquired at each of a time t, a time t−1, a time t−2 . . . , etc. The frames included in the input image PI are acquired moment to moment as the input frame I_{src} that relates to each time. For each of the input frames I_{src}, the motions (the global motion gm and the local motion lm) of the image of the input frame I_{src} with respect to the image of the reference frame I_{ref} are estimated.

Warping is performed successively for the image of each of the input frames I_{src} based on the local motion Lm that is estimated. The input frames I_{src} for which the warping is performed are successively stored in the first storage buffer 30. In other words, the input frames I_{src} each of which position was adjusted based on the local motion Lm are successively added to a first stored frame LM that is stored in the first storage buffer 30.

Warping of each of the input frames I_{src} is performed successively based on the global motion gm that is estimated. The input frames I_{src} for which the warping is performed are successively stored in the second storage buffer 35. In other words, the input frames I_{src} each of which position was adjusted based on the global motion gm are successively added to a second stored frame GM that is stored in the second storage buffer 35.

For example, the input frames I_{src} include a first input frame and a second input frame. A third input frame is obtained by adjusting a position of the first input frame based on a first motion (the local motion Lm of the first input frame). The third input frame is added to the first stored frame LM. A fourth input frame is obtained by adjusting a position of the second input frame based on a second motion (the local motion Lm of the second input frame). The fourth input frame is added to the first stored frame LM. A fifth input frame is obtained by adjusting the position of the first input frame based on a third motion (the global motion gm of the first input frame). The fifth input frame is added to the second stored frame GM. A sixth input frame is obtained by adjusting the position of the second input frame based on a fourth motion (the global motion gm of the second input frame). The sixth input frame is added to the second stored frame GM.

For example, an output frame Iₒ is generated by synthesizing the input frame I_{src} at the time t, the first stored frame LM, and the second stored frame GM. Thereby, a high quality image is generated in which the noise is suppressed.

For example, one direction inside the image of the reference frame I_{ref} or the input frame I_{src} is taken as an x-axis direction. A direction perpendicular to the x-axis direction is taken as a y-axis direction.

One direction inside the image of the output frame Iₒ, the first stored frame LM, or the second stored frame GM is taken as an X-axis direction. A direction perpendicular to the X-axis direction is taken as a Y-axis direction.

In the input frame I_{src}, the value of the pixel positioned at the coordinates (x, y) is defined as a value I_{src}(x, y). The value I_{src}(x, y) is, for example, a scalar that corresponds to the luminance, etc. The value I_{src}(x, y) may be a vector that expresses red-blue-green (RGB), brightness and hue (YUV), etc. In the output frame Iₒ, the value of the pixel positioned at the coordinates (X, Y) is defined as O(X, Y).

In the reference frame I_{ref}, the value of the pixel positioned at the coordinates (x, y) is defined as I_{ref}(x, y). For example, one frame of the input image PI is used as the reference frame I_{ref}.

The resolution of the first stored frame LM (the first processed image) is, for example, the same as the resolution of the input frame I_{src} (the second image). The resolution is, for example, the number of pixels included in the lateral width•vertical width of the image. The resolution of the first stored frame LM may be, for example, 2 times, 3 times, or 4 times the resolution of the input frame I_{src}. The resolution of the first stored frame LM may be lower than the resolution of the input frame I_{src}. Similarly, the resolution of the second stored frame GM (the second processed image) may be the same as the resolution of the input frame I_{src}. The resolution of the second stored frame GM may be higher than or lower than the resolution of the input frame I_{src}. For example, the resolution of the first stored frame LM and the resolution of the second stored frame GM are set to be high. Thereby, for example, the image quality is increased. For example, a super-resolution effect is obtained.

The value of the pixel positioned at the coordinates (X, Y) of the first stored frame LM is B_{LM}(X, Y). The value of the pixel positioned at the coordinates (X, Y) of the second stored frame GM is B_{GM}(X, Y).

The image processing device 100 may include a first stored weight buffer 31 and a second stored weight buffer 36. For example, the weighting of each pixel is performed (the importance is determined) as appropriate when synthesizing the first stored frame LM, the second stored frame GM, and the input frame I_{src}. The information of the weights of each of the pixels is stored in the first stored weight buffer 31 and the second stored weight buffer 36.

For example, the weight of the pixel positioned at the coordinates (X, Y) of the first stored frame LM is W_{LM}(X, Y). The weight of the pixel positioned at the coordinates (X, Y) of the second stored frame GM is W_{GM}(X, Y). The resolution of the information of the weights stored in the first stored weight buffer 31 is, for example, the same as the resolution of the first stored frame LM. The resolution of the weight information stored in the second stored weight buffer 36 is, for example, the same as the resolution of the second stored frame GM.

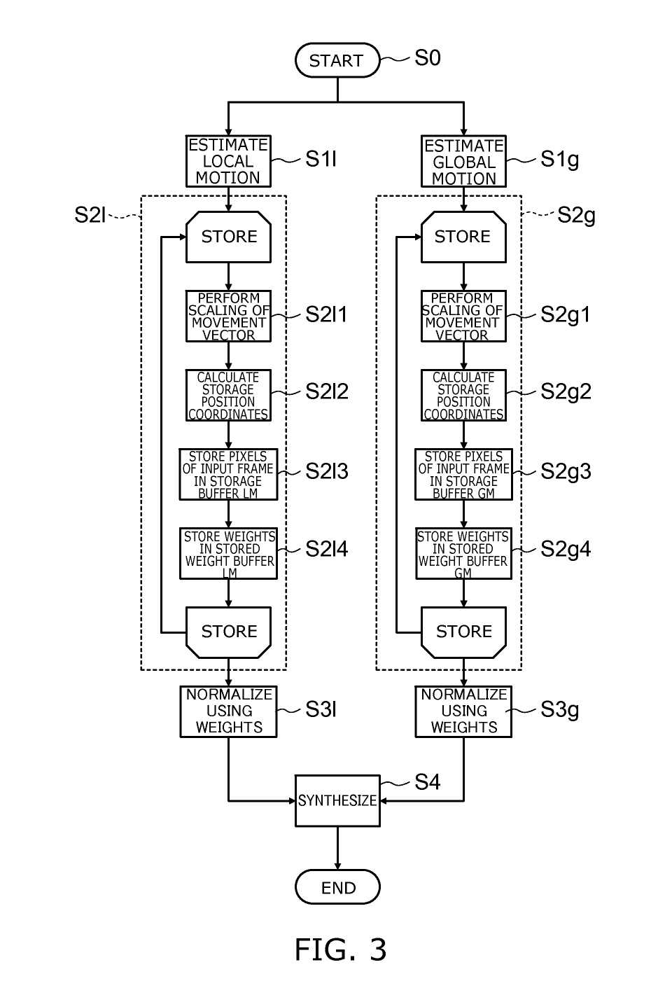

FIG. 3 is a schematic view showing the image processing method according to the first embodiment.

As shown in FIG. 3, the image processing method according to the embodiment includes an acquisition process (step S0), a local motion estimation process (step S1l), a first storage process (step S2l), a first weight normalization process (step S3l), a global motion estimation process (step S1g), a second storage process (step S2g), a second weight normalization process (step S3g), and a synthesis process (step S4).

For example, the image of the reference frame I_{ref} and the image of the input frame I_{src} are acquired in step S0.

Step S1l is performed by, for example, the local motion estimator 10. In step S1l, the vector (the motion vector) that expresses the motion of the position of the image of the input frame I_{src} with respect to the position of the image of the reference frame I_{ref} is calculated. In step S1l, the motion vector that corresponds to the local motion is calculated. For example, the image of the input frame I_{src} is subdivided into multiple regions (blocks). The configuration of each of the blocks is, for example, a rectangle. The portion to which each of the blocks corresponds is searched from inside the image of the reference frame I_{ref}. The motion vector is sensed from the difference between the position of the block in the input frame I_{src} and the position of the portion searched in the reference frame I_{ref}.

Each of the blocks has, for example, a length M₁ along the x-axis direction and a length M₂ along the y-axis direction. For example, the position of the block positioned ith in the x-axis direction and jth in the y-axis direction inside the image of the input frame I_{src} is (i, j).

The motion vector is estimated for each block. For example, an error function such as mean absolute difference (MAD) or the like is used. The MAD is expressed by

$$MAD ( i , j , u ) = \frac{1}{{M}_{1} {M}_{2 }} {\sum }_{0 \leq m < {M}_{1} , 0 \leq n < {M}_{2}} \vert \begin{matrix}{I}_{src} ( {M}_{1} i + m , {M}_{2} j + n ) - \\ {I}_{ref} ( {M}_{1} i + m + {u}_{x} , {M}_{2} j + n + {u}_{y} )\end{matrix} \vert . \qquad [ Formula 1 ]$$

The motion vector is expressed by

u=(uₓ, u_{y})^{t} [Formula 2].

“T” is the transpose. The mean squared error may be used as the error function.

The algorithm (the block matching algorithm) that searches the portion corresponding to the block of the input frame I_{src} from the image of the reference frame I_{ref} is expressed by the following formula.

$${u}_{LM} ( i , j ) = {argmin}_{- W \leq {u}_{x} \leq W , - W \leq {u}_{y} \leq W} MAD ( i , j , {( {u}_{x} , {u}_{y} )}^{T} ) \qquad [ Formula 3 ]$$

The range of search is the rectangular region from −W to W. For example, the range of search is the region of −W≦x≦W and −W≦y≦W. The vector u_{LM}(i, j) is the motion vector corresponding to the local motion of the block positioned at the position (i, j).

The search for uₓ and u_{y} to minimize the error function E is expressed by

$${argmin}_{- W \leq {u}_{x} \leq W , - W \leq {u}_{y} \leq W} E . \qquad [ Equation 4 ]$$

The motion vector u_{LM}(x, y) of each pixel inside the block is the same as the motion vector of the block. Namely,

u_{LM}(x, y):=u_{LM}(i, j) [Formula 5].

For example, the motion vector may not be sensed by the method recited above. For example, a motion vector that is used for compression by video encoding such as MPEG2 may be used. The motion vector of a compressed video image that is decoded by a decoder may be used. For example, a pre-provided motion vector may be read from a storage medium.

Step S1g is performed by, for example, the global motion estimator 20. In step S1g, a parameter that expresses the motion of the position of the image of the input frame I_{src} with respect to the position of the image of the reference frame I_{ref} is calculated. In step S1g, the parameter that corresponds to the global motion is calculated. The parametric motion that expresses the motion of the entire screen is determined. For example, the parametric motion is determined using the Lucas-Kanade method. Thereby, the motion vector is determined.

The parametric motion expresses the motion using a parameterized projection. For example, the motion of the coordinates (x, y) is expressed as follows using an affine transformation.

$$p ( x , y ) a = [ \begin{matrix}x & y & 1 & 0 & 0 & 0 \\ 0 & 0 & 0 & x & y & 1\end{matrix} ] [ \begin{matrix}{a}_{0} \\ {a}_{1} \\ {a}_{2} \\ {a}_{3} \\ {a}_{4} \\ {a}_{5}\end{matrix} ] \qquad [ Equation 6 ]$$

The vector a=(a₀, a₁, a₂, a₃, a₄, a₅)^{T} is a parameter that expresses the motion.

The parameter that expresses the motion of the entire screen is estimated using the Lucas-Kanade method. The Lucas-Kanade method includes processes LK1 to LK4.

The Gradient

$$∇ {I}_{ref} = ( \frac{\partial {I}_{ref}}{\partial x} , \frac{\partial {I}_{ref}}{\partial y} ) \qquad [ Formula 7 ]$$

is calculated in the process LK1.

The Hessian matrix H

$$H = {\sum }_{x , y} {( ∇ {I}_{ref} ( p ( x , y ) {a}^{( t - 1 )} ) p ( x , y ) )}^{T} ( ∇ {I}_{ref} ( p ( x , y ) {a}^{( t - 1 )} ) p ( x , y ) ) \qquad [ Formula 8 ]$$

is calculated in the process LK2.

In the process LK3,

$$Δ a = {H}^{- 1} {\sum }_{x , y} {( ∇ {I}_{ref} ( p ( x , y ) {a}^{( t - 1 )} ) p ( x , y ) )}^{T} ( {I}_{src} ( x , y ) - {I}_{ref} ( p ( x , y ) {a}^{( t - 1 )} ) ) \qquad [ Formula 9 ]$$

is calculated.

The updating of

a^{(t)}=a^{(t-1)}+Δa [Formula 10]

is calculated in the process LK4. The processes LK2 to LK4 are repeated a specified number of times. t is the number of repetitions. Thereby, the parameter of the vector a is determined.

The motion vector u_{GM}(x, y) is expressed by

u_{GM}(x, y)=p(x, y)a−(x, y)^{T} [Formula 11].

Thereby, the motion vector can be determined at any coordinate position.

For example, the parametric motion may be determined using another method. A characteristic point inside the image is calculated for each of the two frames (e.g., the reference frame I_{ref} and the input frame I_{src}). The characteristic point of the image of the reference frame I_{ref} and the characteristic point of the image of the input frame I_{src} are given a correspondence. Thereby, the parametric motion may be determined.

Based on the motion vector calculated in step S1l, the input frame I_{src} is stored in the first storage buffer 30 in step S2l. For example, step S2l includes a first scaling process (step S2l1), a first coordinate calculation process (step S2l2), a first storage process (step S2l3), and a first weight storage process (step S2l4).

The scale of the motion vector calculated in step S1l is transformed in step S2l1. For example, the motion vector has, for example, the same resolution as the input frame I_{src}. The resolution of the motion vector is transformed into the resolution of the first stored frame LM. The transformation is expressed by

U_{LM}(x, y)=ρu_{LM}(x, y) [Formula 12].

A vector U_{LM}(x, y) is the motion vector that is subjected to the scale transformation. ρ is the ratio of the resolution of the first stored frame LM to the resolution of the input frame I_{src}.

In step S2l2, the position (a first storage coordinate) where the value I_{src}(x, y) of the pixel of the input frame I_{src} is stored is determined. The position of the storage is expressed using the motion vector subjected to the scale transformation. The position in the first stored frame LM where the value I_{src}(x, y) of the pixel of the input frame I_{src} is stored is expressed by

$${D}_{LM} ( x , y ) = ρ [ \begin{matrix}x \\ y\end{matrix} ] + {U}_{LM} ( x , y ) . \qquad [ Formula 13 ]$$

ρ is the ratio of the resolution of the first stored frame LM to the resolution of the input frame I_{src}.

In step S2l3, the value I_{src}(x, y) of the pixel of the input frame I_{src} is added to the first stored frame LM. The first storage coordinate that is determined in step S2l2 is used in the addition. There are cases where the first storage coordinate has few components. The position (a first vicinity discrete ordinate) where the value I_{src}(x, y) of the pixel is stored is expressed by

$${X}_{LM} = [ \begin{matrix}{X}_{LM} \\ {Y}_{LM}\end{matrix} ] = round ( {D}_{LM} ( x , y ) ) . \qquad [ Formula 14 ]$$

Each component of the first storage coordinate being rounded to the nearest whole number is expressed by

round(D_{LM}(x, y)) [Formula 15].

The first vicinity discrete ordinate is expressed by

X_{LM}=(X_{LM}, Y_{LM})^{T} [Formula 16].

At the first vicinity discrete ordinate, the storage is implemented by adding the value I_{src}(x, y) of the pixel of the input frame I_{src}. In other words, the calculation of B_{LM}(X_{LM}, Y_{LM})+=I_{src}(x, y) is implemented. z+=a expresses a being added to z. The value of the pixel of the input frame I_{src} is stored in the first stored frame LM stored in the first storage buffer 30.

In step S2l4, the information of the weight is stored in the first stored weight buffer 31. Namely, the calculation of W_{LM}(X_{LM}, Y_{LM})+=1.0 is performed. The weight is determined by the number of times the multiple input frames are added.

For example, in the first stored frame LM, the weight (the number of times) of the storage is different by pixel. In step S2l4, the value of the pixel of the first stored frame LM is divided by the information of the weight stored in the first stored weight buffer 31.

$${O}_{LM} ( X , Y ) = \frac{{B}_{LM} ( X , Y )}{{W}_{LM} ( X , Y )} \qquad [ Formula 17 ]$$

Thereby, a first stored output frame (a first stored output image) that is normalized by the weight of the storage is obtained. O_{LM}(X, Y) is the value of the pixel positioned at the coordinates (X, Y) of the first stored output frame. In other words, the first stored output image is calculated from the first stored frame LM based on a weight for each pixel of the first stored frame LM (the first processed image).

Based on the motion vector calculated in step S1g, the input frame I_{src} is stored in the second storage buffer 35 in step S2g. For example, step S2g includes a second scaling process (step S2g1), a second coordinate calculation process (step S2g2), a second storage process (step S2g3), and a second weight storage process (step S2g4).

In step S2g1, the scale of the motion vector that is calculated in step S1g is transformed. For example, there are cases where the resolution of the input frame I_{src} and the resolution of the second stored frame GM stored in the second storage buffer 35 are different from each other. For example, the resolution of the motion vector is the same as the resolution of the resolution and the input frame I_{src}. The resolution of the motion vector is transformed into the resolution of the second stored frame GM. The transformation is expressed by

U_{GM}(x, y)=ρu_{GM}(x, y) [Formula 18].

The vector U_{GM}(x, y) is the motion vector subjected to the scale transformation. ρ is the ratio of the resolution of the second stored frame GM to the resolution of the input frame I_{src}.

In step S2g2, the position (a second storage coordinate) is determined where the value I_{src}(x, y) of the pixel of the input frame is stored. The storage position is expressed using the motion vector subjected to the scale transformation. The position in the second stored frame GM where the value I_{src}(x, y) of the pixel of the input frame is stored is expressed by

$${D}_{GM} ( x , y ) = ρ [ \begin{matrix}x \\ y\end{matrix} ] + {U}_{GM} ( x , y ) . \qquad [ Formula 19 ]$$

ρ is the ratio of the resolution of the second stored frame GM to the resolution of the input frame I_{src}.

In step S2g3, the value I_{src}(x, y) of the pixel of the input frame is stored in the second stored frame GM. The second storage coordinate that is determined in step S2g2 is used in the storage. There are cases where the second storage coordinate has few components. The position (a second vicinity discrete ordinate) where the value I_{src}(x, y) of the pixel is stored is expressed by

$${X}_{GM} = [ \begin{matrix}{X}_{GM} \\ {Y}_{GM}\end{matrix} ] = round ( {D}_{GM} ( x , y ) ) . \qquad [ Formula 20 ]$$

Each component of the second storage coordinate being rounded to the nearest whole number is expressed by

round(D_{GM}(x, y)) [Formula 21].

The second vicinity discrete ordinate is expressed by

X_{GM}=(X_{GM}, Y_{GM})^{T} [Formula 22].

The storage is implemented by adding the value I_{src}(x, y) of the pixel of the input frame at the second vicinity discrete ordinate. Namely, B_{GM}(X_{GM}, Y_{GM})+=I_{src}(x, y) is calculated.

In step S2g4, the information of the weight is stored in the second stored weight buffer 36. Namely, W_{GM}(X_{GM}, Y_{GM})+=1.0 is calculated.

In step S3g, the value of the pixel of the second stored frame GM is divided by the information of the weight stored in the second stored weight buffer 36.

$${O}_{GM} ( X , Y ) = \frac{{B}_{GM} ( X , Y )}{{W}_{GM} ( X , Y )} \qquad [ Formula 23 ]$$

Thereby, a second stored output frame (a second stored output image) that is normalized by the weight of the storage is obtained. The value of the pixel positioned at the coordinates (X, Y) of the second stored output frame is expressed by O_{GM}(X, Y). In other words, the second stored output image is calculated from the second stored frame GM based on a weight for each pixel of the second stored frame GM (the second processed image).

In the example, the resolution of the first stored frame LM and the resolution of the second stored frame GM are the same. The resolution of the first stored frame LM and the resolution of the second stored frame GM may be different from each other. In the case where the resolution of the first stored frame LM and the resolution of the second stored frame GM are different from each other, for example, a step of transforming at least one of the resolutions into the resolution of the output frame is provided.

In step S4, the output frame O(X, Y) that is ultimately output is determined using the first stored output frame, the second stored output frame, and the reference frame I_{ref}.

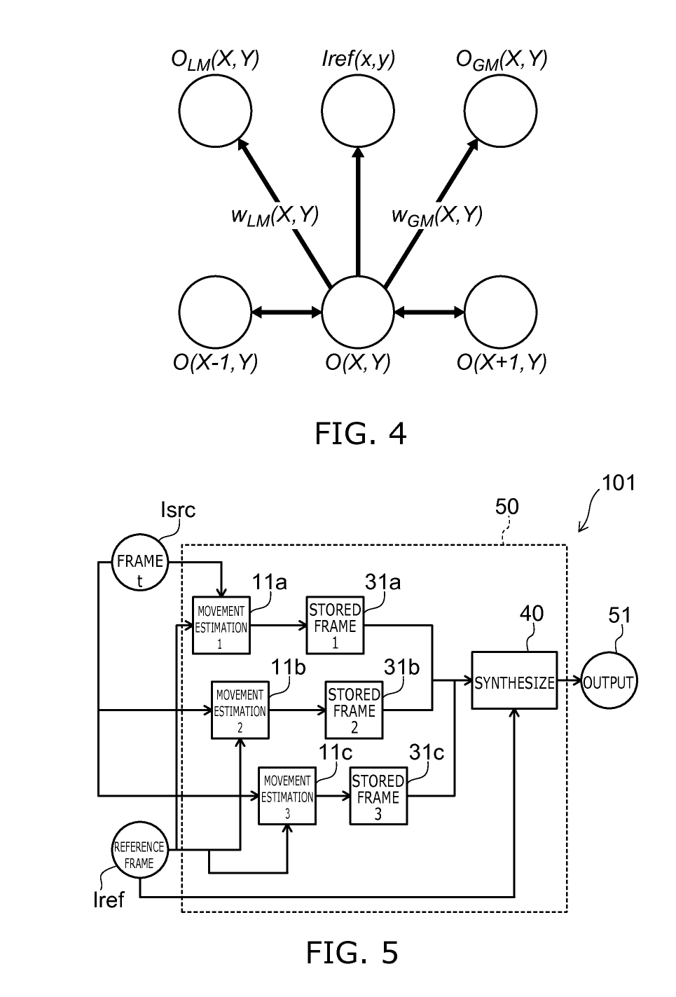

FIG. 4 is a schematic view showing the image processing method according to the embodiment.

FIG. 4 shows the processing of synthesizing the frames in step S4. For example, as shown in FIG. 4, the value O(X, Y) of the pixels of the output frame is determined to reduce the difference between the value O(X, Y) of the pixels of the output frame and each of the value O_{LM}(X, Y) of the pixels of the first stored output frame, the value O_{GM}(X, Y) of the pixels of the second stored output frame, and the value Iref(x, y) of the pixels of the reference frame.

The output frame is calculated to reduce the error (a first error) of the output frame with respect to the first stored frame LM. The output frame may be calculated to reduce the error (a second error) of the output frame with respect to the input frame.

The difference is evaluated using, for example, the following formula (Evaluation function 1).

Evaluation Function 1:

$$\hat{O} = {arg min}_{O} {\sum }_{X , Y} \{ \begin{matrix}{‖ {I}_{ref} ( ⌊ \frac{X}{ρ} ⌋ , ⌊ \frac{Y}{ρ} ⌋ ) - O ( X , Y ) ‖}_{{L}_{2}}^{2} + \\ {‖ {O}_{LM} ( X , Y ) - O ( X , Y ) ‖}_{{L}_{2}}^{2} + \\ {‖ {O}_{GM} ( X , Y ) - O ( X , Y ) ‖}_{{L}_{2}}^{2}\end{matrix} \} \qquad [ Formula 24 ]$$

The L2-norm is expressed by

∥x∥_{L}_{₃}² [Formula 25].

In the case where x is a vector, the L2-norm is the sum of squares of the components of x. In the case where x is a scalar, the L2-norm is the square of x. The entire image of the output frame is expressed by O. The entire image of the appropriate output frame is expressed by

Ô [Formula 26].

For example, the output image includes the first pixel disposed at the first position (e.g., the coordinates (X, Y)). The error of the output image is evaluated based on the difference (a first difference) between the value O(X, Y) of the first pixel and the value O_{LM}(X, Y) of the pixel disposed at the first position in the first stored output image and the difference (a second difference) between the value O(X, Y) of the first pixel and the value O_{GM}(X, Y) of the pixel disposed at the first position in the second stored output image. The appropriate output frame is calculated to reduce the error.

The appropriate output frame may be determined by the following formula (Evaluation function 2).

Evaluation Function 2:

$$\hat{O} = {arg min}_{O} {\sum }_{X , Y} \{ \begin{matrix}{‖ {I}_{ref} ( ⌊ \frac{X}{ρ} ⌋ , ⌊ \frac{Y}{ρ} ⌋ ) - O ( X , Y ) ‖}_{{L}_{2}}^{2} + \\ {‖ {O}_{LM} ( X , Y ) - O ( X , Y ) ‖}_{{L}_{2}}^{2} + \\ {‖ {O}_{GM} ( X , Y ) - O ( X , Y ) ‖}_{{L}_{2}}^{2} + \\ {‖ O ( X - 1 , Y ) - O ( X , Y ) ‖}_{{L}_{2}}^{2} + \\ {‖ O ( X , Y - 1 ) - O ( X , Y ) ‖}_{{L}_{2}}^{2} + \\ {‖ O ( X + 1 , Y ) - O ( X , Y ) ‖}_{{L}_{2}}^{2} + \\ {‖ O ( X , Y + 1 ) - O ( X , Y ) ‖}_{{L}_{2}}^{2}\end{matrix} \} \qquad [ Formula 27 ]$$

Thereby, for example, the value of the pixel at the coordinates (X, Y) and the values of the pixels around the coordinates (X, Y) change smoothly.

The output image includes a second pixel that is adjacent to (around) the first pixel. The coordinates of the second pixel are, for example, (X−1, Y). The error is calculated based on the first difference, the second difference, and the difference (a third difference) between the value O(X−1, Y) of the second pixel and the value O(X, Y) of the first pixel.

The appropriate output frame may be determined by the following formula (Evaluation function 3).

Evaluation Function 3:

$$\hat{O} = {arg min}_{O} {\sum }_{X , Y} \{ \begin{matrix}\vert {I}_{ref} ( ⌊ \frac{X}{ρ} ⌋ , ⌊ \frac{Y}{ρ} ⌋ ) - O ( X , Y ) \vert + \\ \vert {O}_{LM} ( X , Y ) - O ( X , Y ) \vert + \\ \vert {O}_{GM} ( X , Y ) - O ( X , Y ) \vert + \\ \vert {O}_{GM} ( X , Y ) - O ( X , Y ) \vert + \\ \vert O ( X - 1 , Y ) - O ( X , Y ) \vert + \\ \vert O ( X , Y - 1 ) - O ( X , Y ) \vert + \\ \vert O ( X + 1 , Y ) - O ( X , Y ) \vert + \\ \vert O ( X , Y + 1 ) - O ( X , Y ) \vert\end{matrix} \} \qquad [ Formula 28 ]$$

Here, the L1-norm is expressed by

|x| [Formula 29].

In the case where x is a vector, the L1-norm is the sum of absolute values of the components of x. In the case where x is a scalar, the L1-norm is the absolute value of x. To minimize these values, an iterative method such as a steepest descent method, etc., may be used to determine the output frame. Thereby, for example, the effects of outliers are reduced when determining the appropriate output frame. This is robust for outliers.

For example, there are cases where an error is included in the value O_{LM}(X, Y) of the pixel of the first stored frame LM and the value O_{GM}(X, Y) of the pixel of the second stored frame GM; and these values cannot be trusted 100%. The error occurs, for example, in the estimation of the motion vector. The error may be considered as a weight when determining the appropriate output frame. For example, in the case where the error does not occur in the estimation of the motion vector, the difference between the first stored output frame and the reference frame I_{ref} corresponds to the distribution of noise. For example, the difference between the second stored output frame and the reference frame I_{ref} corresponds to the distribution of noise.

$${w}_{LM} ( X , Y ) = exp ( - \frac{{( {I}_{ref} ( ⌊ \frac{X}{ρ} ] , ⌊ \frac{Y}{ρ} ⌋ ) - {O}_{LM} ( X , Y ) )}^{2}}{2 {σ}^{2}} ) \\ {w}_{GM} ( X , Y ) = exp ( - \frac{{( {I}_{ref} ( ⌊ \frac{X}{ρ} ] , ⌊ \frac{Y}{ρ} ⌋ ) - {O}_{GM} ( X , Y ) )}^{2}}{2 {σ}^{2}} ) \qquad [ Formula 30 ]$$

The difference between the first stored output frame and the reference frame I_{ref} at the position of the coordinates (X, Y) is the function w_{LM}(X, Y). The difference between the second stored output frame and the reference frame I_{ref} at the position of the coordinates (X, Y) is the function w_{GM}(X, Y). w_{LM}(X, Y) and w_{GM}(X, Y) are any value in the range from 0 to 1. For example, an error may occur in the estimation of the motion vector when the values are small. σ is the standard deviation of the noise. For example, considering the error as the weight, Evaluation function 1 becomes

$$\hat{O} = {arg min}_{O} {\sum }_{X , Y} \{ \begin{matrix}{‖ {I}_{ref} ( ⌊ \frac{X}{ρ} ⌋ , ⌊ \frac{Y}{ρ} ⌋ ) - O ( X , Y ) ‖}_{{L}_{2}}^{2} + \\ {w}_{LM} ( X , Y ) {‖ {O}_{LM} ( X , Y ) - O ( X , Y ) ‖}_{{L}_{2}}^{2} + \\ {w}_{GM} ( X , Y ) {‖ {O}_{GM} ( X , Y ) - O ( X , Y ) ‖}_{{L}_{2}}^{2}\end{matrix} \} . \qquad [ Formula 31 ]$$

Similarly, the error may be considered as the weight in Evaluation function 2 and Evaluation function 3.

The weight of the first stored frame LM and the weight of the second stored frame GM may be modified appropriately when determining the output frame. For example, the weight may be modified according to the brightness of the image. For example, the first stored frame LM is given priority when imaging a bright image. For example, the weight may be modified according to the texture (how the brightness changes inside the image) of the image. For example, the second stored frame GM is given priority when the change of the brightness inside the image is gradual (when imaging a distant view, etc.).

Multiple input frames I_{src} are added to both the first stored frame LM and the second stored frame GM. Thereby, for example, the image quality of the image increases for both the first stored frame LM and the second stored frame GM. In the embodiment, the first stored frame LM and the second stored frame GM are synthesized. Thereby, the image quality of the output frame increases.

For example, there is an image processing device of a first reference example in which a stored frame (e.g., the second stored frame) that corresponds to the global motion is used without using a stored frame (e.g., the first stored frame) that corresponds to the local motion. In the reference example, the multiple input frames I_{src} are added and stored. Thereby, the noise decreases. For example, the reference example is for the motion of hand unsteadiness. Therefore, global motion is estimated in which the entire screen is expressed by the parameters of rotation and translation. On the other hand, there are cases where local motion (e.g., the motion of a human, etc.) in the screen cannot be handled when adding the input frame I_{src}. There are cases where noise occurs due to the local motion in the screen.

For example, there is an image processing device of a second reference example in which a stored frame that corresponds to the local motion is used without using a stored frame that corresponds to the global motion. The local motion is estimated in the second reference example. The input frame I_{src} is added to the stored frame based on the local motion that is estimated. Thereby, for example, the local motion in the screen can be handled. On the other hand, in the estimation of the local motion, for example, the entire screen is subdivided into multiple regions. The number of pixels used to estimate the motion of one of the subdivided regions is less than the number of pixels of the entire screen. The number of pixels used to estimate the local motion is less than that of the global motion. Thereby, there are cases where the precision is low for the estimation of the local motion. In the second reference example, there are cases where the addition (the storage) of the input frame I_{src} fails.

Conversely, in the image processing device according to the embodiment, both the first stored frame that corresponds to the local motion and the second stored frame that corresponds to the global motion are used in the output frame. Thereby, an output frame that handles the local motion in the screen and has high-precision addition can be obtained.

For example, there is an image processing device of a third reference example in which the synthesis of multiple input frames I_{src} is performed in the calculation of the output frame. Multiple storage buffers are used in the image processing device of the third reference example. Multiple input frames I_{src} are stored in each of the multiple storage buffers. The multiple input frames I_{src} that are stored in each of the multiple storage buffers are read and added when calculating the output frame. In the third reference example, the number of storage buffers used is the same as the number of added input frames I_{src}. There are cases where many storage buffers must be prepared.

Conversely, in the image processing device according to the embodiment, the input frame I_{src} is added moment to moment to the first storage buffer 30 and to the second storage buffer 35. When calculating the output frame, the first stored frame LM to which the input frame I_{src} is already added is read; and the second stored frame GM to which the input frame I_{src} is already added is read. The embodiment can be implemented using the two storage buffers even in the case where the number of input frames I_{src} is high.

### Second Embodiment

FIG. 5 is a schematic view showing an image processing device according to a second embodiment.

The image processing device 101 shown in FIG. 5 includes the calculator 50 and the output unit 51. The calculator 50 includes a first motion estimator 11a, a second motion estimator 11b, a third motion estimator 11c, a first storage buffer 31a, a second storage buffer 31b, a third storage buffer 31c, and the synthesizer 40.

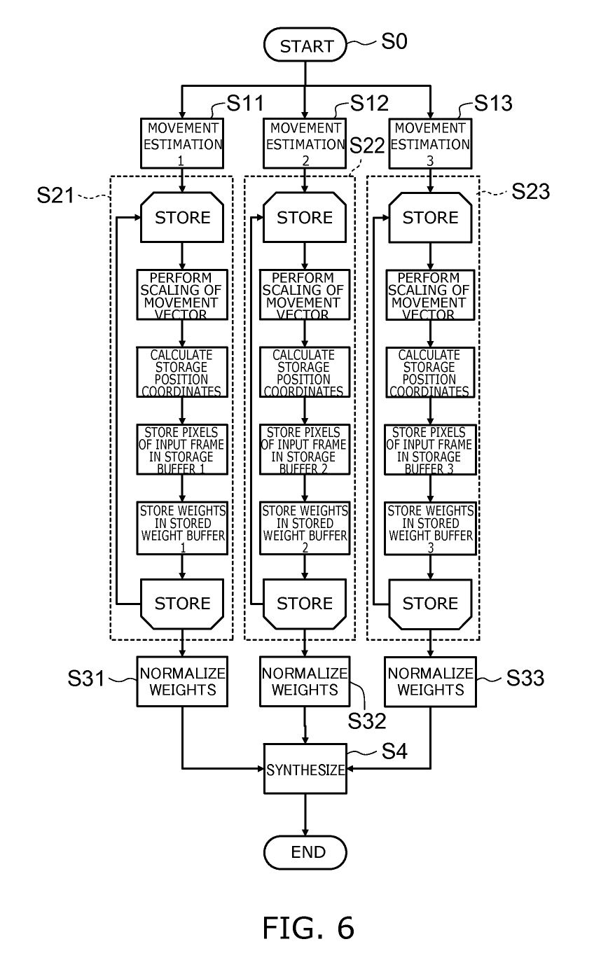

FIG. 6 is a schematic view showing the image processing method according to the second embodiment.

As shown in FIG. 6, the image processing method according to the second embodiment includes the acquisition process (step S0), a first motion estimation process (step S11), a second motion estimation process (step S12), a third motion estimation process (step S13), a first storage process (step S21), a second storage process (step S22), a third storage process (step S23), a first weight normalization process (step S31), a second weight normalization process (step S32), a third weight normalization process (step S33), and the synthesis process (step S4).

In each of step S0, step S11, step S12, and step S13, processing that is similar to step S1l of the first embodiment is performed; and the motion vectors are calculated. For example, in each of step S11, step S12, and step S13, the entire image is subdivided into multiple blocks. For example, each of the blocks is a rectangle. Each of the blocks for the first motion estimator 11a has, for example, a vertical length of 8 pixels and a lateral length of 8 pixels. For example, each of the blocks for the second motion estimator 11b has a vertical length of 32 pixels and a lateral length of 32 pixels. For example, each of the blocks for the third motion estimator 11c has a vertical length of 128 pixels and a lateral length of 128 pixels.

For example, in step S11, a motion vector u₁(x, y) is calculated by the first motion estimator 11a. For example, in step S12, a motion vector u₂(x, y) is calculated by the second motion estimator 11b. For example, in step S13, a motion vector u₃(x, y) is calculated by the third motion estimator 11c.

In each of step S21, step S22, and step S23, processing similar to that of step S2l of the first embodiment is performed; and the input frame I_{src} is stored. For example, a first stored frame 32a is stored in the first storage buffer 31a. In step S21, the input frame I_{src} is added to the first stored frame 32a based on the motion vector u₁(x, y). For example, a second stored frame 32b is stored in the second storage buffer 31b. In step S22, the input frame I_{src} is added to the second stored frame 32b based on the motion vector u₂(x, y). For example, a third stored frame 32c is stored in the third storage buffer 31c. In step S23, the input frame I_{src} is added to the third stored frame 32c based on the motion vector u₃(x, y).

In each of step S31, step S32, and step S33, processing similar to that of step S3l of the first embodiment is performed. For example, a first stored output frame O₁(X, Y) is determined from the first stored frame 32a in step S31. In step S32, a second stored output frame O₂(X, Y) is determined from the second stored frame 32b. In step S33, a third output frame O₃(X, Y) is determined from the third stored frame 32c.

In step S4, the synthesizer 40 generates the output frame by synthesizing the first stored output frame O₁(X, Y), the second stored output frame O₂(X, Y), the third output frame O₃(X, Y), and the reference frame I_{ref}. For example, the following formula which is a modification of Evaluation function 1 is used in the synthesis.

$$\hat{O} = {arg min}_{O} {\sum }_{X , Y} \{ \begin{matrix}{‖ {I}_{ref} ( ⌊ \frac{X}{ρ} ⌋ , ⌊ \frac{Y}{ρ} ⌋ ) - O ( X , Y ) ‖}_{{L}_{2}}^{2} + \\ {‖ {O}_{1} ( X , Y ) - O ( X , Y ) ‖}_{{L}_{2}}^{2} + \\ {‖ {O}_{2} ( X , Y ) - O ( X , Y ) ‖}_{{L}_{2}}^{2} + \\ {‖ {O}_{3} ( X , Y ) - O ( X , Y ) ‖}_{{L}_{2}}^{2}\end{matrix} \} \qquad [ Formula 32 ]$$

Similarly, a modification of Evaluation function 2, Evaluation function 3, or the Evaluation function 4 may be used. The image that is generated is output from the output unit 51.

The entire screen is subdivided into the multiple blocks by the motion estimator. In the case where the size of each of the subdivided blocks is small, fine motions inside the image can be handled. In the case where the size of the blocks is large, the noise is suppressed by adding the input frame I_{src}. In the embodiment, blocks of three sizes are used. Thereby, an image that can handle fine motions and suppress the noise can be obtained. Three or more motion estimations may be combined.

### Third Embodiment

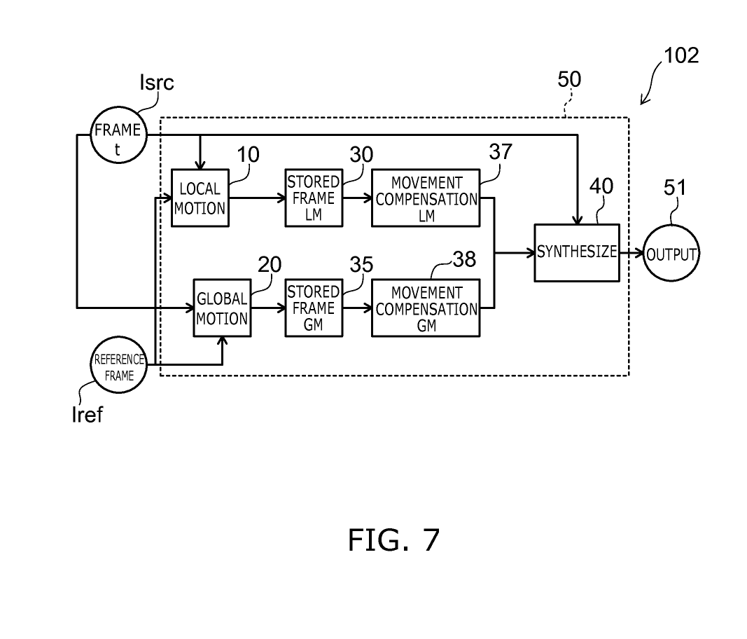

FIG. 7 is a schematic view showing an image processing device according to a third embodiment.

As shown in FIG. 7, the image processing device 102 includes the calculator 50 and the output unit 51. The calculator 50 includes the local motion estimator 10, the global motion estimator 20, the first storage buffer 30, the second storage buffer 35, a first motion compensator 37, a second motion compensator 38, and the synthesizer 40.

A description similar to the description of the image processing device 100 is applicable to the local motion estimator 10, the global motion estimator 20, the first storage buffer 30, the second storage buffer 35, and the output unit 51.

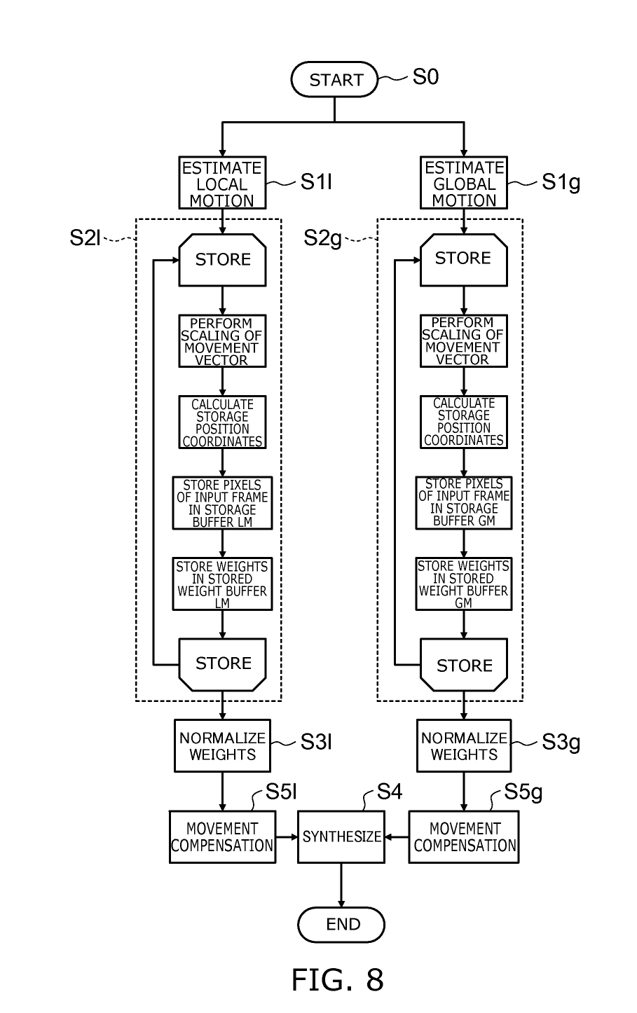

FIG. 8 is a schematic view showing the image processing method according to the third embodiment.

As shown in FIG. 8, the image processing method according to the third embodiment includes the acquisition process (step S0), the local motion estimation process (step S1l), the first storage process (step S2l), the first weight normalization process (step S3l), the global motion estimation process (step S1g), the second storage process (step S2g), the second weight normalization process (step S3g), the synthesis process (step S4), a first motion compensation process (step S5l), and a second motion compensation process (step S5g).

A description that is similar to the description of the first embodiment is applicable to the acquisition process (step S0), the local motion estimation process (step S1l), the first storage process (step S2l), the first weight normalization process (step S3l), the global motion estimation process (step S1g), the second storage process (step S2g), and the second weight normalization process (step S3g).

In step S3l, for example, the first stored output frame O_{LM}(X, Y) is output from the first storage buffer 30. In step S3g, for example, the second stored output frame O_{GM}(X, Y) is output from the second storage buffer 35.

Position matching with respect to the image of the reference frame I_{ref} is performed when adding the image of the input frame I_{src}. In other words, the image of the first stored output frame O_{LM}(X, Y) and the image of the second stored output frame O_{GM}(X, Y) correspond to images at the same time as when the reference frame I_{ref} was imaged. The first stored output frame O_{LM}(X, Y) and the second stored output frame O_{GM}(X, Y) have temporally the same phase as the reference frame I_{ref}. The image of the first stored output frame O_{LM}(X, Y) and the image of the second stored output frame O_{GM}(X, Y) correspond to images at a time that is different from the time when the input frame I_{src} was imaged.

In step S5l, the position of the image of the first stored output frame O_{LM}(X, Y) is restored (motion compensation is performed) to the position of the image of the input frame I_{src}. In other words, the position of the image of the first stored output frame O_{LM}(X, Y) is caused to match the position of the image of the input frame I_{src}. Thereby, the first motion compensation image is obtained.

In step S5g, the motion compensation of the second stored output frame O_{GM}(X, Y) is performed. In other words, the position of the image of the second stored output frame O_{GM}(X, Y) is caused to match the position of the image of the input frame I_{src}. Thereby, the second motion compensation image is obtained. By the motion compensation, the first stored output frame O_{LM}(X, Y) and the second stored output frame O_{GM}(X, Y) are transformed into images of the same time as when the input frame I_{src} was imaged.

For example, the motion vector is a vector expressing the motion from the input frame I_{src} to the reference frame I_{ref}. By using the motion vector to restore the position of the output frame, the temporal phase of the output frame can be caused to match the temporal phase of the input frame I_{src}. Step S51 is performed by, for example, the first motion compensator 37.

The first stored output frame (the first motion compensation image) that has the compensated first motion from the first stored frame is derived according to the first motion (the motion of the input frame I_{src} with respect to the reference frame I_{ref} estimated by the first motion estimation processing).

The second stored output frame (the second motion compensation image) that has the compensated second motion from the second stored frame is derived according to the second motion (the motion of the input frame I_{src} with respect to the reference frame I_{ref} estimated by the second motion estimation processing).

The relationship between the coordinates (x, y) of the input frame I_{src} and the coordinates (X, Y) of the first stored frame is as follows.

$${( x , y )}^{T} = {( \frac{1}{ρ} X , \frac{1}{ρ} Y )}^{T} \qquad [ Formula 33 ]$$

The motion vector at the coordinates (X, Y) is expressed by

$${U}_{LM} ( x , y ) = {U}_{LM} ( \frac{1}{ρ} X , \frac{1}{ρ} Y ) = {( {U}_{x} ( \frac{1}{ρ} X , \frac{1}{ρ} Y ) , {U}_{v} ( \frac{1}{ρ} X , \frac{1}{ρ} Y ) )}^{T} . \qquad [ Formula 34 ]$$

Here, Uₓ is the x-component of the motion vector; and U_{y} is the y-component of the motion vector. As described in the first embodiment, there is a possibility that

$${U}_{LM} ( \frac{1}{ρ} X , \frac{1}{ρ} Y ) \qquad [ Formula 35 ]$$

may not exist because the motion vector is a vector expressing a discrete pixel position. Therefore, the motion vector is interpolated using linear interpolation, etc. The motion compensation is calculated as follows.

$${O}_{LM}^{t} ( X , Y ) = {O}_{LM} ( X + {U}_{x} ( \frac{1}{ρ} X , \frac{1}{ρ} Y ) , Y + {U}_{y} ( \frac{1}{ρ} X , \frac{1}{ρ} Y ) ) \qquad [ Formula 36 ]$$

The first stored output frame O_{LM}(X, Y) is defined only for a discrete pixel position. Therefore, for example, it is sufficient to perform the calculation by using an interpolation such as linear interpolation, etc.

In step S5g, the motion compensation of the second stored output frame O_{GM}(X, Y) is performed. The motion compensation of the second stored output frame O_{GM}(X, Y) is performed by processing similar to the motion compensation of step S5l. Step S5g is performed by, for example, the second motion compensator 38.

In step S4, the first stored output frame O^{t}_{LM}(X, Y) (the first motion compensation image), the second stored output frame O^{t}_{GM}(X, Y) (the second motion compensation image), and the input frame I_{src} are synthesized. The synthesis is performed by, for example, the synthesizer 40. For example, the error of the synthesis is evaluated using the L2-norm. The following formula which is a modification of Evaluation function 1 is used.

$$\hat{O} = {arg min}_{O} {\sum }_{X , Y} \{ \begin{matrix}{‖ {I}_{src} ( ⌊ \frac{X}{ρ} ⌋ , ⌊ \frac{Y}{ρ} ⌋ ) - O ( X , Y ) ‖}_{{L}_{2}}^{2} + \\ {‖ {O}_{LM}^{t} ( X , Y ) - O ( X , Y ) ‖}_{{L}_{2}}^{2} + \\ {‖ {O}_{GM}^{t} ( X , Y ) - O ( X , Y ) ‖}_{{L}_{2}}^{2}\end{matrix} \} \qquad [ Formula 37 ]$$

Thereby, the output frame is calculated. The output frame is output from the output unit 51.

The first stored output image includes a fifth region corresponding to the second region of the second image. The second stored output image includes a sixth region corresponding to the fourth region of the second image. The position of the first stored output image is restored using the first vector. Namely, the position of the fifth region in the first stored output image is caused to match the position of the second region in the second image. Thereby, the first motion compensation image is calculated.

The position of the second stored output image is restored using the second vector. Namely, the position of the sixth region in the second stored output image is caused to match the position of the fourth region in the second image. Thereby, the second motion compensation image is calculated. The output image is calculated using the first motion compensation image and the second motion compensation image. For example, the output image is calculated in which the second image, the first motion compensation image, and the second motion compensation image are synthesized.

In the embodiment, motion compensation is performed. Thereby, the output frame corresponds to an image at the same time as when the input frame I_{src} was imaged. Thereby, the video image can be output. Multiple input frames I_{src} that are input from an image sensor or a television image can be output as a high quality video image.

### Fourth Embodiment

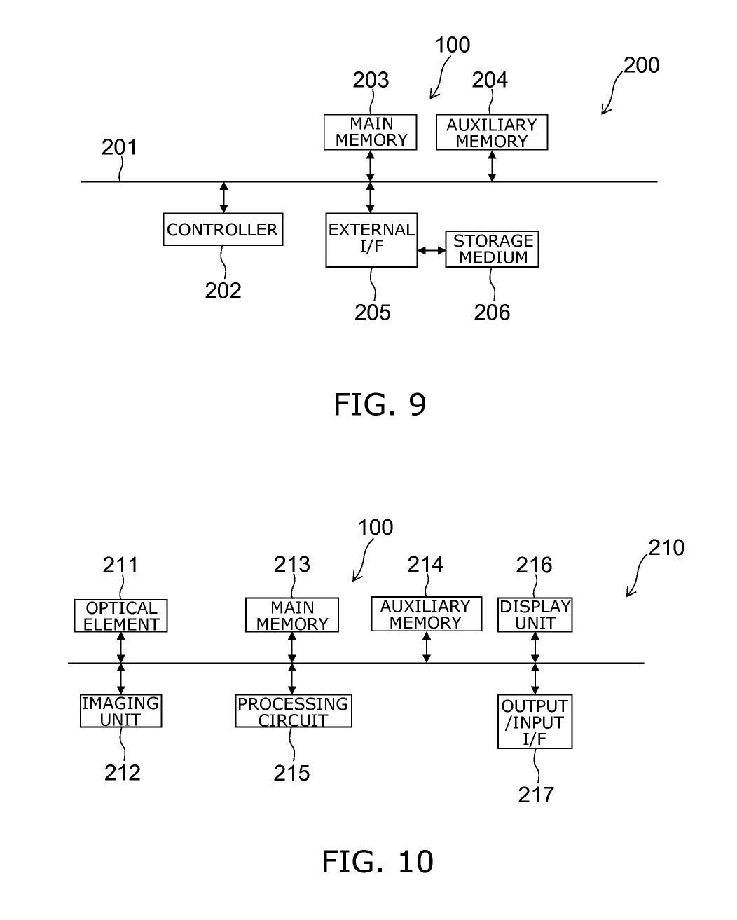

FIG. 9 is a schematic view showing an image processing device according to a fourth embodiment.

A computer device 200 shown in FIG. 9 is, for example, capable of implementing the image processing described in the first to third embodiments. The computer device 200 is, for example, an image processing device.

The computer device 200 shown in FIG. 9 includes a bus 201, a controller 202, a main memory 203, an auxiliary memory 204, and an external I/F 205. The controller 202, the main memory 203, the auxiliary memory 204, and the external I/F 205 are connected to the bus 201.

The auxiliary memory 204 includes, for example, a hard disk, etc. For example, a storage medium 206 is connected to the external I/F 205. The storage medium 206 includes, for example, CD-R, CD-RW, DVD-RAM, DVD-R, etc.

For example, a program for executing the processing of the image processing device 100 is stored in the main memory 203 or the auxiliary memory 204. The processing of the image processing device 100 is executed by the controller 202 executing the program. In the execution of the processing of the image processing device 100, for example, the main memory 203 or the auxiliary memory 204 is used as a buffer that stores each frame.

For example, the program for executing the processing of the image processing device 100 is preinstalled in the main memory 203 or the auxiliary memory 204. The program may be stored in the storage medium 206. In such a case, for example, the program is installed as appropriate in the computer device 200. The program may be acquired via a network.

### Fifth Embodiment

FIG. 10 is a schematic view showing an imaging device according to a fifth embodiment.

As shown in FIG. 10, the imaging device 210 includes an optical element 211, an imaging unit (an imaging element) 212, a main memory 213, an auxiliary memory 214, one or more processing circuits 215, a display unit 216, and an output/input I/F 217.

For example, a lens or the like is provided in the optical element 211. A portion of the light from the subject toward the imaging device 210 passes through the optical element 211 and is incident on the imaging unit 212. The imaging unit 212 includes, for example, a CMOS image sensor, a CCD image sensor, etc. The image of the reference frame I_{ref} and the image of the input frame I_{src} are imaged by the optical element 211 and the imaging unit 212. For example, the program for executing the processing of the image processing device 100 is pre-stored in the main memory 213 or the auxiliary memory 214. The program is executed by the one or more processing circuits 215; and the processing of the image processing device 100 is executed. In other words, in the example, the image processing device 100 is realized by the main memory 213, the auxiliary memory 214, and the one or more processing circuits 215. In the execution of the processing of the image processing device 100, for example, the main memory 213 or the auxiliary memory 214 is used as a buffer that stores each frame. The output frame is output by the processing of the image processing device 100. For example, the output frame is displayed by the display unit 216 via the output/input I/F 217.

In other words, the imaging device 210 includes, for example, the imaging unit 212 and any image processing device according to the embodiments recited above. The imaging unit 212 acquires, for example, the image information (e.g., the reference frame, the input frame, the first image, the second image, etc.) that is acquired by the image processing device.

According to the embodiment of the invention, an image processing device, an image processing method, and an imaging device that generate a high quality image are provided.

Hereinabove, embodiments of the invention are described with reference to specific examples. However, the invention is not limited to these specific examples. For example, one skilled in the art may similarly practice the invention by appropriately selecting specific configurations of components such as the input frame, the reference frame, the stored frame, the calculator, the local motion estimator, the global motion estimator, the first storage buffer, the second storage buffer, the synthesizer, the output unit, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all image processing devices, imaging devices, and image processing methods practicable by an appropriate design modification by one skilled in the art based on the image processing devices, the imaging devices, and the image processing methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image processing device, comprising a calculator,
the calculator acquiring image information including a reference frame and a plurality of target frames,
the calculator estimating a first motion of each of the plurality of the target frames with respect to the reference frame and deriving a first stored frame by adding the plurality of the target frames each of which positions was adjusted based on the first motion,
the calculator estimating a second motion of each of the plurality of the target frames with respect to the reference frame and deriving a second stored frame by adding the plurality of the target frames each of which positions was adjusted based on the second motion, wherein the estimation of the second motion is different from the estimation of the first motion, and
the calculator generating an output frame using the first stored frame and the second stored frame.

2. The device according to claim 1, wherein the calculator generates the output frame to reduce a first error of the output frame with respect to the first stored frame.

3. The device according to claim 2, wherein the calculator evaluates the first error using at least one of the L2-norm of the first error or the L1-norm of the first error.

4. The device according to claim 1, wherein the calculator generates the output frame to reduce a second error of the output frame with respect to the target frames.

5. The device according to claim 1, wherein
the calculator derives a first stored output frame from the first stored frame according to the first motion, the first motion being compensated in the first stored output frame,
the calculator derives a second stored output frame from the second stored frame according to the second motion, the second motion being compensated in the second stored output frame, and
the calculator generates the output frame using the first stored output frame and the second stored output frame.

6. The device according to claim 1, wherein
the first motion is expressed by at least one vector, and the second motion is expressed by at least one vector, and
the number of vectors expressing the first motion is different from the number of vectors expressing the second motion.

7. The device according to claim 6, wherein
the first motion is local motion expressed by at least two vectors, and
the second motion is global motion expressed by one vector.

8. An imaging device, comprising:
the image processing device according to claim 1; and
an imaging element that images the target frames.

9. An image processing device, comprising a calculator,
the calculator acquiring a first image and a second image, the first image having a first region and a third region, the first region including first image information, the third region including third image information, the second image having a second region and a fourth region, the second region including second image information corresponding to the first image information, the fourth region including fourth image information corresponding to the third image information,
the calculator deriving a first processed image by moving, based on a first vector, at least a portion of second image information inside the second image and adding the at least a portion of the second image information to the first image after the movement, wherein the first vector corresponds to the difference between a position of the first region and a position of the second region,
the calculator deriving a second processed image by moving, based on a second vector, at least a portion of fourth image information inside the second image and adding the at least a portion of the fourth image information to the first image after the movement, wherein the second vector corresponds to the difference between a position of the third region and a position of the fourth region, and
the calculator generating an output image using the first processed image and the second processed image.

10. The device according to claim 9, wherein the fourth region is the entire second image.

11. The device according to claim 9, wherein a resolution of the first processed image is higher than a resolution of the second image.

12. The device according to claim 9, wherein
the calculator calculates a first stored output image from the first processed image based on a weight for each pixel of the first processed image,
the calculator calculates a second stored output image from the second processed image based on a weight for each pixel of the second processed image, and
the calculator generates the output image using the first stored output image and the second stored output image.

13. The device according to claim 12, wherein
the calculator adds a plurality of images to the first processed image and the second processed image, and
the weights are determined according to the number of times the images are added.

14. The device according to claim 12, wherein
the output image includes a first pixel disposed at a first position inside the output image, and
the calculator evaluates an error of the output image based on a first difference and a second difference,
the first difference being a difference between a value of the first pixel and a value of a pixel disposed at the first position in the first stored output image,
the second difference being a difference between the value of the first pixel and a value of a pixel disposed at the first position in the second stored output image.

15. The device according to claim 14, wherein the error is calculated using a sum of squares of each component of the first difference and a sum of squares of each component of the second difference.

16. The device according to claim 14, wherein the error is calculated using a sum of absolute values of each component of the first difference and a sum of absolute values of each component of the second difference.

17. The device according to claim 12, wherein the calculator generates the output image by synthesizing the first image, the first stored output image, and the second stored output image.

18. An imaging device, comprising:
the image processing device according to claim 9; and
an imaging element that images the first image.

19. An image processing method, comprising:
acquiring image information including a reference frame and a plurality of target frames;
estimating a first motion of each of the plurality of the target frames with respect to the reference frame and deriving a first stored frame by adding the plurality of the target frames each of which position was adjusted based on the first motion;
estimating a second motion of each of the plurality of the target frames with respect to the reference frame and deriving a second stored frame by adding the plurality of the target frames each of which positions was adjusted based on the second motion, wherein the estimation of the second motion is different from the estimation of the first motion; and
generating an output frame using the first stored frame and the second stored frame.

20. The method according to claim 19, wherein the output frame is calculated based on the first stored output frame and the second stored output frame, the first stored output frame is derived by compensating the first motion from the first stored frame, and the second stored output frame is derived by compensating the second motion from the second stored frame.

21. An image processing device, comprising one or more processing circuits,
the one or more processing circuits acquiring image information including a reference frame, a first target frame and a second target frame,
the one or more processing circuits estimating a first motion of the first target frame with respect to the reference frame by a first motion estimation processing and estimating a second motion of the second target frame with respect to the reference frame by the first motion estimation processing,
the one or more processing circuits deriving a first stored frame by adding a third target frame and a fourth target frame, the third target frame being obtained by adjusting a position of the first target frame based on the first motion, the fourth target frame being obtained by adjusting a position of the second target frame based on the second motion,
the one or more processing circuits estimating a third motion of the first target frame with respect to the reference frame by a second motion estimation processing and estimating a fourth motion of the second target frame with respect to the reference frame by the second motion estimation processing, the second motion estimation processing being different from the first motion estimation processing,
the one or more processing circuits deriving a second stored frame by adding a fifth target frame and a sixth target frame, the fifth target frame being obtained by adjusting the position of the first target frame based on the third motion, the sixth target frame being obtained by adjusting position of the second target frame based on the fourth motion,
the one or more processing circuits generating an output frame using the first stored frame and the second stored frame.
